(19) United States
(12) Patent Application Publication
(10) Pub. No.: US 2008/0008278 A1
(43) Pub. Date: Jan. 10, 2008

(54) Frequency generation and adjustment

(75) Inventors: Ilkka Kontola, Julkujarvi (FI); Janne Olavi Peltonen, Salo (FI); Harri Valio, Kammenniemi (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/480,560

(22) Filed: Jul. 5, 2006

(51) Int. Cl. H04L 7/00

(52) U.S. Cl. 375/354

(57) ABSTRACT

Circuitry comprising: a frequency controller that generates an output frequency from a clock signal provided to the circuitry; and an external interface for receiving the clock signal and an offset signal associated with a change to the clock signal, wherein the frequency generator is operable to adjust its operation in dependence upon the offset signal.

### FIELD OF THE INVENTION

Embodiments of the present invention relate to frequency generation. In particular, some embodiments relate to frequency generation in Global Navigation Satellite System (GNSS) receiver circuitry.

### BACKGROUND TO THE INVENTION

Some Global Navigation Satellite (GNSS) Systems such as Global Positioning Systems (GPS) and the proposed European system Galileo use Code Division Multiple Access (CDMA). This access scheme enables multiple communication channels to share a single frequency band by using orthogonal chipping codes to spread the data across the full frequency band. The chipping codes are also called pseudo random noise codes. A different chipping code is assigned to each satellite communication channel but all the satellite communication channels share the same frequency band.

Another Global Navigation Satellite System, GLONASS, uses frequency division multiple access. A different frequency band is assigned to each satellite communication channel but all the satellite communication channels share the same chipping code.

For the sake of simplicity, reference will now be made to a GNSS receiver, however, it should be appreciated that embodiments of the invention find application in other types of radio receivers.

A GNSS receiver is a complex system. It typically comprises an RF engine for demodulating RF signals, a measurement engine for acquiring the satellite communication channels, for tracking the satellite communication channels and for recovering transmitted data from each of the satellite communication channels and a position engine for solving time and geometric unknowns using the recovered data. Acquisition is a complex process. The communication channel parameters are unknown and therefore “processing” is required to find those parameters. For a GPS system, which uses CDMA, the unknown parameters of the communication channel are the chipping code, the phase of the chipping code and the exact carrier frequency as modified by, for example, Doppler shifting.

Tracking is a less complex process. The communication parameters are known but need to be maintained.

However, the tracking process may be sensitive to sudden unexpected changes in chipping code, code phase or carrier frequency. If tracking is lost, the time-intensive acquisition process may need to be repeated.

There is always a desire to be able to implement a system as cheaply as possible and to be able to use resources as effectively as possible.

In a satellite positioning system implementation there are certain functions that are carried out in positioning-specific circuitry and other functions that may be carried out in circuitry of a device that hosts the positioning-specific circuitry.

The inventors have considered using a clock of a host device as the time reference in the positioning-specific circuitry. However, it may be necessary for the host to adjust its clock and such a change may result in the loss of tracking.

### BRIEF DESCRIPTION OF THE INVENTION

According to one embodiment of the invention there is provided circuitry comprising:

a frequency controller that generates an output frequency from a clock signal provided to the circuitry; and an external interface for receiving the clock signal and an offset signal associated with a change to the clock signal,

wherein the frequency generator is operable to adjust its operation in dependence upon the offset signal.

According to another embodiment of the invention there is provided method comprising: receiving an external clock signal from a host system for use as a time reference for frequency generation; receiving an offset signal from the host system indicating a future change to the clock signal; receiving the changed clock signal from the host system: and using the offset signal to control a generated frequency affected by the changed clock signal.

According to one embodiment of the invention there is provided a system comprising a host for performing a first function and circuitry for performing a second different function, wherein the host comprises a first interface for providing a clock signal and for providing an offset signal associated with a change to the clock signal, and the circuitry comprises: a second interface, for connection to the first interface, for receiving the clock signal and the offset signal from the host; and a frequency controller for generating an output frequency from the received clock signal; wherein the frequency generator is operable to adjust its operation in dependence upon the offset signal.

### BRIEF DESCRIPTION OF THE DRAWINGS

For a better understanding of the present invention reference will now be made by way of example only to the accompanying drawings in which:

FIG. 1 schematically illustrates a system for obtaining a position from GNSS satellites;

FIG. 2A schematically illustrates the system during channel acquisition;

FIG. 2B schematically illustrates the system during data recovery and tracking; and

FIG. 3 illustrates a method of channel acquisition and tracking including compensation of a communication channel parameter.

### DETAILED DESCRIPTION OF EMBODIMENTS OF THE INVENTION

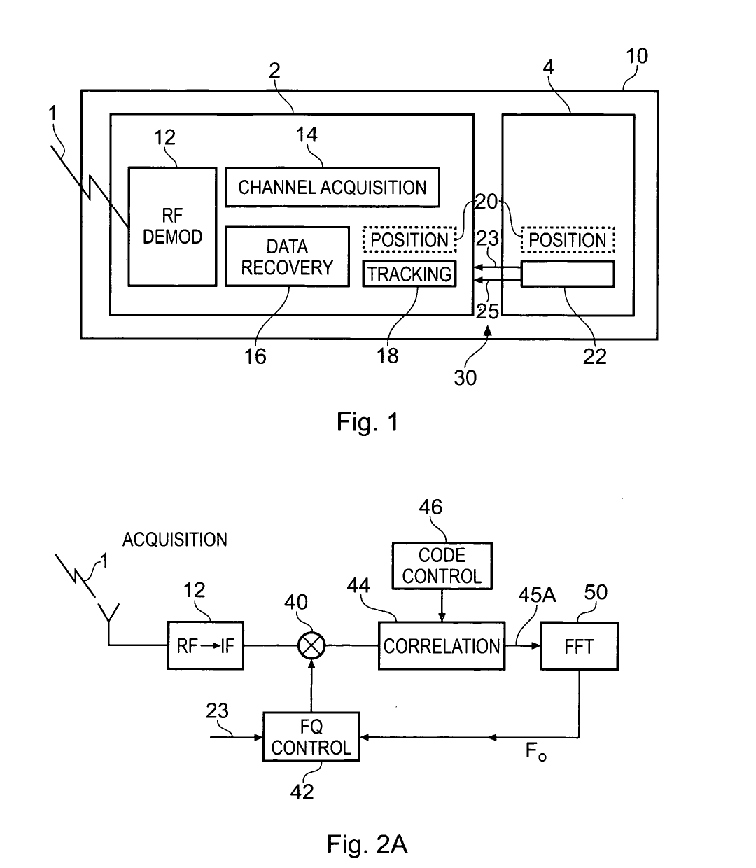

FIG. 1 schematically illustrates a system 10 for obtaining a position from GNSS satellites.

The system 10 comprises circuitry 2 that is dedicated to positioning the system 10. This circuitry 2 includes an RF engine 12 for demodulating RF signals, a measurement engine 14, 16, 18 for acquiring the satellite communication channels, for tracking the satellite communication channels and for recovering transmitted data from each of the satellite communication channels and possibly a position engine 20 for solving time and geometric unknowns using the recovered data to determine the receiver system's position.

The engines may be provided via dedicated circuitry such as interconnected electronic components, integrated circuits or undedicated circuitry such as a programmable microprocessor.

The system 10 also comprises a host system 4 comprising a host clock 22. The host clock 22 provides a time signal 23 to the circuitry 2 which is used as a time reference. The host system 4 typically uses the host clock 22 in the provision of some functions other than satellite positioning such as, for example, cellular radio telephone operation or computer bus operation. The clock 22 may be produced by a crystal oscillator. However clocks are subject to errors for example a crystal oscillator's frequency may vary with ambient temperature. The host system 4 typically has a mechanism for correcting a clock signal 23 provided by the clock. Such a mechanism may introduce sudden changes to the clock signal 23.

There is a signaling interface 30 between the host system 4 and the positioning circuitry 2. The host system 4 provides the clock signal 23 and also an offset signal 25 across this interface 30 to the positioning circuitry 2.

Encoded data 1 is received via a communications channel that has been encoded using at least two parameters, typically frequency and a chipping code.

A GNSS satellite communications channel is separated from the other satellite communication channels of the same GNSS by a unique combination of chipping code and frequency. In GPS, each satellite shares the same frequency band but has a different chipping code, whereas in GLONASS each satellite uses the same chipping code but has a different frequency band. As each channel is associated with a different satellite that has a different velocity relative to a receiver, each communications channel has, because of, for example, the Doppler effect, its own unknown frequency within a nominal carrier frequency band. A communication channel can therefore be defined by the parameters: chipping code, chipping code phase, and frequency as affected by Doppler shift.

The chipping code phase gives an initial indication of the time of flight to the satellite from the receiver system 10 and is referred to as a pseudo-range. It must be corrected for at least receiver clock error compared to the satellite clock before it represents a true range. It may also be corrected for satellite clock and orbit errors and RF signal transmission errors.

The measurement engine 14, 16, 18 comprises a channel acquisition block 14 for acquiring the satellite communication channels, a tracking block 18 for tracking the satellite communication channels and a data recovery block 16 for recovering transmitted data from each of the satellite communication channels.

Acquisition, performed by channel acquisition bock 14, is the process that positioning circuitry 2 uses to find satellite communication channels given a set of starting conditions (or uncertainties). This involves achieving frequency lock and code phase alignment and normally decoding data sufficiently to enable determination of a pseudo-range for each of four satellites.

Over time, the relative velocities of the receiver to each satellite may change, the error in the receiver clock may vary, the position of the satellite may vary or the satellite's atomic clock may vary. For these reasons, it is important that the receiver is able to track each acquired communication channel independently so that once acquired it is not subsequently lost.

Tracking of a communications channel, performed by the tracking block 18, involves the maintenance of the at least two parameters that define the channel and occasionally updating Satellite Data information as this changes from time to time (every 2 hours for GPS).

A position engine 20 solves at least four equations with four unknowns using the four pseudo-ranges to make a three dimensional position fix. The four unknowns are the three degrees of freedom in the receiver position (x, y, z) and the receiver time according to the ‘true’ satellite time reference (phase code offset). The positioning circuitry 2 must therefore acquire four separate communication channels and obtain four pseudo-ranges.

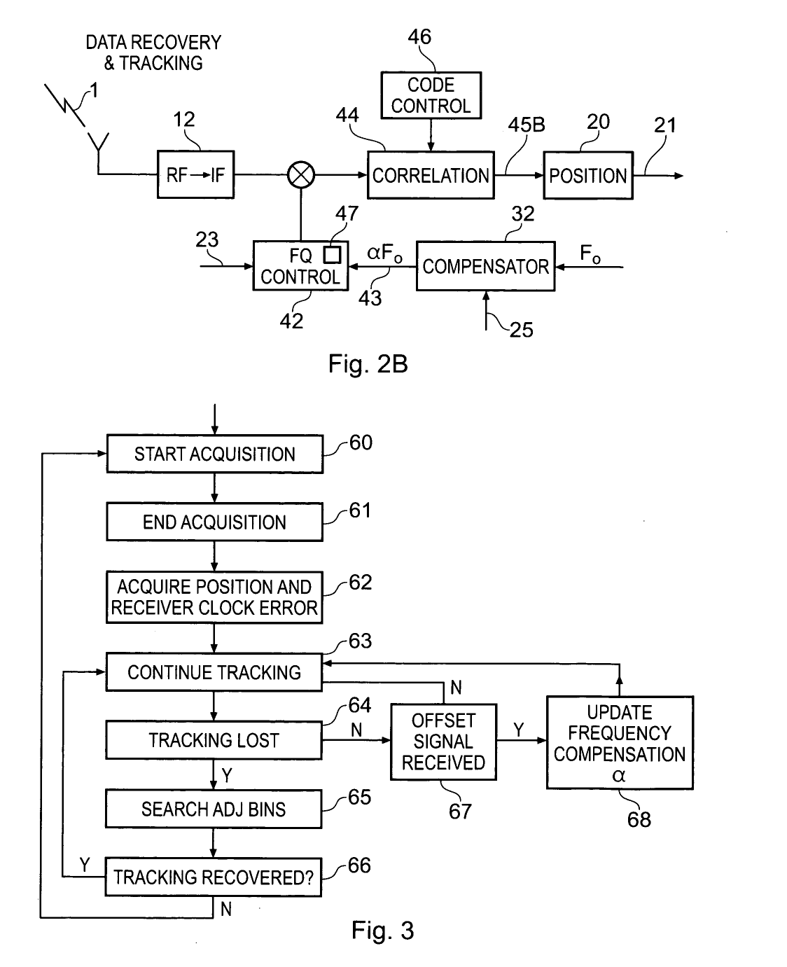

FIG. 2A schematically illustrates positioning circuitry 2 during channel acquisition.

Encoded data 1 is received via an antenna and converted by the RF engine 12, it is then frequency shifted from an intermediate frequency IF to a baseband frequency by mixer 40 under the control of frequency controller 42. The frequency controller 42 may be a numerically controlled oscillator (NCO) 47 which uses as its clock the time reference 23 received from the host's clock 22.

The baseband frequency signal is correlated by correlator block 44 to produce a partially encoded signal 45A.

In this example, the positioning circuitry 2 is a GPS receiver and the encoded data is encoded using a satellite specific chipping code but a common frequency band offset by a satellite specific Doppler shift.

The correlator block 44 may be implemented as described in relation to FIGS. 3 or 6 of WO 2005/104392 A1 as a group correlator.

In a group correlator, a chipping code is shifted into a code shift register of size N at a rate of one bit per chip. Simultaneously, the baseband signal is shifted into a sample shift register of size N at a rate of one bit per chip. Every N chips the content of the code shift register is transferred to a code register. Every chip the N bits of the code register are cross correlated with the respective N bits of the sample shift register. The code registers may be cascaded in series so that at any one time each holds a different sequential N bit portion of the same chipping code. In this case, each of the cascaded code registers is cross-correlated with the sample shift register in each chip period.

The same process may occur for different chipping codes in parallel group correlators.

The code controller 46 controls the codes and code parts provided to the respective code shift registers. The code controller may be programmable so that different code formats may be used.

The correlator block 44 because it correlates a part of the chipping code of size N, against N sequential samples, has an effective sampling rate of N times the chipping rate and is therefore able to search an increased frequency bandwidth. In fact it is able to search the whole of the frequency bandwidth for each of the chipping codes in parallel. This enables the correlator block to identify for received encoded data the relevant chipping codes and estimates of their respective chipping code phases without having to first determine their respective frequencies.

The output from the correlator block 44, the partially encoded data 45A is decoded using frequency analysis 50 such as Fast Fourier Transform. The frequency analysis 50 identifies the frequencies Fₒ of the communication channels which are returned to the frequency controller 42 where they may be used as a numeric input to the NCO.

If one samples over one entire CDMA code period (for GPS this is 1023 chips in 1 millisecond, the code epoch) then the usable bandwidth will be less than 500 Hz. Consequently, each communication channel has a bandwidth of <500 Hz at its own central frequency Fₒ.

FIG. 2B schematically illustrates positioning circuitry 2 during data recovery and tracking.

When the frequency Fₒ is received at the frequency controller 42, it tunes the frequency to the correct frequency bin for the communication channel. The code controller 40 then supplies the whole of the chipping code for the communications channel to the correlator block 44 which cross correlates the whole of the chipping code with the baseband signal at the correct frequency bin.

The correlator block 44 is therefore able to determine a chipping code offset between the baseband signal and the chipping code. This indicates the time difference between the receiver and the satellite associated with the communications channel from the receiver's time reference 23. This time difference or pseudo-range 45B is provided to the position engine 20.

Once the correct satellite frequency and chipping code phase is determined, their rates of change are predictable and within the normal abilities of a tracking control loop. Uncertainty due to the stability of the receiver's time reference and the user's movements (in particular, their acceleration) may be maintained by the tracking control loop given a certain bandwidth.

However, the time reference may suddenly change as a result in a sudden change or off-set to the clock signal 23 provided by the clock 22 of the host. Such a sudden change may result in the loss of tracking. The inventors have developed an innovative solution to this problem.

As an example, the host system 4 may be a cellular telecommunications engine with an associated clock reference 22 and the positioning circuitry may be a GPS sub-system 2 operating as a slave to the clock reference 22. The time reference 22 may be time locked to a cellular telecommunications network according to a standard such as WCDMA, CDMA, CDMA2000, GSM etc. Offset corrections to the clock reference 22 may therefore be dependent upon the network and too great for the GPS sub-system to maintaining frequency lock.

When the frequency of the clock signal 23 is to be changed by an offset O at time T, an update signal 25 is sent from the host system 4 to the positioning circuitry 2. In a first example, the update signal 25 includes an indication of the offset O and an indication of the time T which is used by the positioning circuitry to time compensation for the offset O. In another example, the update signal 25 includes only an indication of the offset O and the positioning circuitry times compensation for the offset O according to a predetermined schedule. The predetermined schedule may be, for example, the offset O is applied when the next update signal 25 is received or that the offset O is applied a predetermined time after receiving the update signal 25 containing that offset.

According to the first example, the update signal 25 may include explicit values for the offset O and the time T or values from which explicit values may be derived. For example, the host system 4 may use a crystal oscillator in its clock and adjust its frequency when a change in temperature (which has a known and calibrated effect on the crystal oscillator) is detected. In this scenario the host system 4 will use the temperature change or new temperature to calculate an offset adjustment O for the clock 22 to be applied at time T but it may either send as the update signal 25 the temperature/temperature change or the offset O along with the time T. If the temperature/temperature change is sent, the positioning circuitry 2 uses a calibration table for the crystal oscillator to convert it to an offset value O.

The update signal (O, T) 25 is provided to compensator 32, which applies a multiplicative adjusting factor a to the numeric input 43 of the NCO at time T.

The factor α is initially 1 before compensation has occurred and may be expressed as

$${\prod }_{n} ( 1 - {O}_{n} )$$

where Oₙ represents the nth offset O and O₀ is zero. α is the cumulative offset to the time reference 23 since the last acquisition.

The controlling input signal 43 to the NCO is therefore a Fₒ with a being updated to a new value at time T.

For example, if Fₒ is 15754 MHz and the first offset O₁ is 0.01 ppm (1×10⁻⁸), then the frequency output by the NCO as a result of the offset and without compensation would increase by 15.753 MHz. To compensate for this, the numeric control signal 43 provided to the NCO is decreased by 15.753 MHz simultaneously with the change in the clock signal 23. This decrease in frequency is in the opposite sense and of substantially the same value as the change that would be caused by the change to the clock signal 23 without compensation. The compensation is for and is synchronized with the offset to the positioning circuitry's time reference. Of course, the resolution of the NCO must be greater than the potential changes resulting from the offset signal 25.

During tracking, the output of the frequency controller 42 is therefore under feed forward open loop control, with the loop control signal (offset signal 25) being provided by the host system 4.

FIG. 3 illustrates a method for compensating a time reference of the positioning circuitry 2 when the ‘foreign’ clock signal 23 on which the time reference is based changes.

The acquisition process starts at block 60 and ends at block 61. Then at block 62, the pseudo-rages are obtained and resolved into a position fix for the positioning circuitry 2 and also a receiver clock error relative to the satellites' clocks (code phase offset). Next the tracking process is commenced at block 63.

In the normal course of events, tracking should not be lost and an offset signal 25 is not received from the host 4, so the method moves through blocks 64 and 67 back to block 63.

If tracking is not lost and an offset signal 25 is received from the host 4, the method moves through blocks 64 and 67 to block 68. At block 68, the effect of an offset O at time T to the clock signal 23 is compensated for by adjusting the controlling input signal 43 to the frequency generator 42 at time T so that the output of the frequency generator 42 which is based on the clock signal 23 and the controlling input signal 43 is substantially unchanged before and after T. The effect caused by the change in the clock signal 23 is cancelled by the change to the controlling input signal 43. The method then returns to block 63.

If tracking is lost, then the method moves from block 63, through block 64 to block 65. At block 65, a search of a portion of the frequency band is performed—the adjacent frequency bins are searched to try and regain frequency lock. If this is successful, the method returns to block 63 but if it is unsuccessful, the method returns to block 60 where the acquisition process is repeated.

Although embodiments of the present invention have been described in the preceding paragraphs with reference to various examples, it should be appreciated that modifications to the examples given can be made without departing from the scope of the invention as claimed. For example, although the frequency compensation in the above described embodiment is carried out using a NCO 47, in other embodiments a plurality of physical oscillators could be used, the physical oscillators used could be selected so that the summation of their outputs matches the size of the change the offset O would cause to the output of the frequency generator 42 and it is added or subtracted to the output of the frequency generator to cancel that change.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I claim:

1. Circuitry comprising:
a frequency controller for generating an output frequency from a clock signal provided to the circuitry; and
an external interface for receiving the clock signal and an offset signal associated with a change to the clock signal,
wherein the frequency generator is operable to adjust its operation in dependence upon the offset signal.

2. Circuitry as claimed in claim 1, wherein the frequency generator is operable to adjust the generated frequency in dependence upon the offset signal.

3. Circuitry as claimed in claim 1, wherein the adjustment to the generated frequency in dependence upon the offset signal compensates for a change to the generated frequency resulting from the change to the clock signal.

4. Circuitry as claimed in claim 1, wherein the adjustment to the generated frequency in dependence upon the offset signal cancels a change to the generated frequency resulting from the change to the clock signal.

5. Circuitry as claimed in claim 1, wherein the frequency controller maintains the same output frequency before and after a change to the clock signal.

6. Circuitry as claimed in claim 1, wherein the offset signal comprises an indication of the change to the clock signal.

7. Circuitry as claimed in claim 1, wherein the offset signal comprises an indication of the change to the clock signal and also an indication of when the change will occur.

8. Circuitry as claimed in claim 1, wherein the frequency generator is operable to start compensation for a change to the clock signal simultaneously with when the change occurs.

9. Circuitry as claimed in claim 1, wherein the frequency generator is operable to adjust its operation in dependence upon the offset signal to compensate for the associated change to the clock signal while the circuitry is maintaining frequency lock with at least one cdma communication channel.

10. Circuitry as claimed in claim 9, wherein the cdma communications channel uses a chipping code of greater than one thousand chips.

11. Circuitry as claimed in claim 9, wherein the circuitry is keeping frequency lock with a plurality of satellite communication channels.

12. Circuitry as claimed in claim 9, wherein the frequency generator comprises a numerically controlled oscillator (NCO) arranged to receive a numeric input signal that is adjusted in dependence upon the offset signal.

13. Circuitry as claimed in claim 12, further comprising circuitry for adjusting the numeric input signal in dependence upon the offset signal.

14. Circuitry as claimed in claim 12, further comprising circuitry for adjusting the numeric input signal in dependence upon a history of received offset signals.

15. Circuitry as claimed in claim 1 operable as GNSS positioning circuitry.

16. A method comprising:
receiving an external clock signal from a host system for use as a time reference for frequency generation;
receiving an offset signal from the host system indicating a future change to the clock signal;
receiving the changed clock signal from the host system: and
using the offset signal to control a generated frequency signal affected by the changed clock signal.

17. A method as claimed in claim 16, wherein using the offset signal to control a generated frequency signal compensates for an effect the changed clock signal has on the generated frequency.

18. A method as claimed in claim 16, wherein using the offset signal to control a generated frequency signal cancels an effect the changed clock signal has on the generated frequency.

19. A method as claimed in claim 16, wherein the generated frequency remains the same before and after the change to the clock signal.

20. A method as claimed in claim 16, wherein the offset signal comprises an indication of the change to the clock signal.

21. A method as claimed in claim 16, wherein the offset signal comprises an indication of the change to the clock signal and also an indication of when the change will occur.

22. A method as claimed in claim 16, wherein the generated frequency is used to maintain frequency lock with at least one cdma communication channel.

23. A system comprising a host for performing a first function and circuitry for performing a second different function, wherein the host comprises a first interface for providing a clock signal and for providing an offset signal associated with a change to the clock signal,
and the circuitry comprises:
a second interface, for connection to the first interface, for receiving the clock signal and the offset signal from the host; and a frequency controller for generating an output frequency from the received clock signal; wherein the frequency generator is operable to adjust its operation in dependence upon the offset signal.
